(19) United States
(12) Patent Application Publication
(10) Pub. No.: US 2020/0076202 A1
(43) Pub. Date: Mar. 5, 2020

(54) CHARGING APPARATUS

(71) Applicant: Asahi Kasei Microdevices Corporation, Tokyo (JP)

(72) Inventor: Shiro TAGA, Tokyo (JP)

(21) Appl. No.: 16/551,779

(22) Filed: Aug. 27, 2019

(30) Foreign Application Priority Data
Aug. 31, 2018 (JP) 2018-163845

(51) Int. Cl. H02J 7/00

(52) U.S. Cl. CPC H02J 7/007

(57) ABSTRACT

Provided is a charging apparatus including a charging section that receives an input signal, charges a battery based on the input signal, and includes a feedback loop that performs feedback control to charge the battery with a predetermined target value; a saturation detecting section that detects saturation of the feedback loop; and a target adjusting section that adjusts the target value, based on a detection result of the saturation detecting section.

The contents of the following Japanese patent application are incorporated herein by reference: 2018-163845 filed in JP on Aug. 31, 2018.

### BACKGROUND

### 1. Technical Field

The present invention relates to a charging apparatus.

### 2. Related Art

A conventional charging apparatus for charging a battery is known that measures input voltage of a switching charger and, when the input voltage drops below a predetermined reference voltage, maintains the input voltage at the reference voltage by reducing the charging current, as shown in Patent Document 1, for example.
Patent Document 1: U.S. Pat. No. 8,338,991

However, the reference voltage for which the transmission efficiency is at maximum differs due to the transmitted power, impedance matching, coupling state of transmission and reception, and other reasons, and therefore it is not easy to maintain optimal power transmission.

### SUMMARY

According to a first aspect of the present invention, provided is a charging apparatus comprising a charging section that receives an input signal, charges a battery based on the input signal, and includes a feedback loop that performs feedback control to charge the battery with a predetermined target value; a saturation detecting section that detects saturation of the feedback loop; and a target adjusting section that adjusts the target value, based on a detection result of the saturation detecting section.

The summary clause does not necessarily describe all necessary features of the embodiments of the present invention. The present invention may also be a sub-combination of the features described above.

### BRIEF DESCRIPTION OF THE DRAWINGS

FIG. 1A shows an example of a configuration of a power supply system 200.

FIG. 1B is a diagram for describing the wireless signal transmitted by the power supply system 200.

FIG. 2 shows an overview of a configuration of the charging apparatus 100 according to an embodiment.

FIG. 3A shows an example of a detailed configuration of the charging apparatus 100 according to a first embodiment.

FIG. 3B shows an example of a timing chart of the charging apparatus 100 according to the first embodiment.

FIG. 4A shows an example of a configuration of the charging apparatus 100 according to a second embodiment.

FIG. 4B shows an example of a timing chart of the charging apparatus 100 according to the second embodiment.

FIG. 4C shows operational points of input nodes of the charging apparatus 100 according to the second embodiment.

FIG. 5A shows an example of a configuration of the charging apparatus 100 according to a third embodiment.

FIG. 5B shows an example of a timing chart of the charging apparatus 100 according to the third embodiment.

FIG. 5C shows operational points of input nodes of the charging apparatus 100 according to the third embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

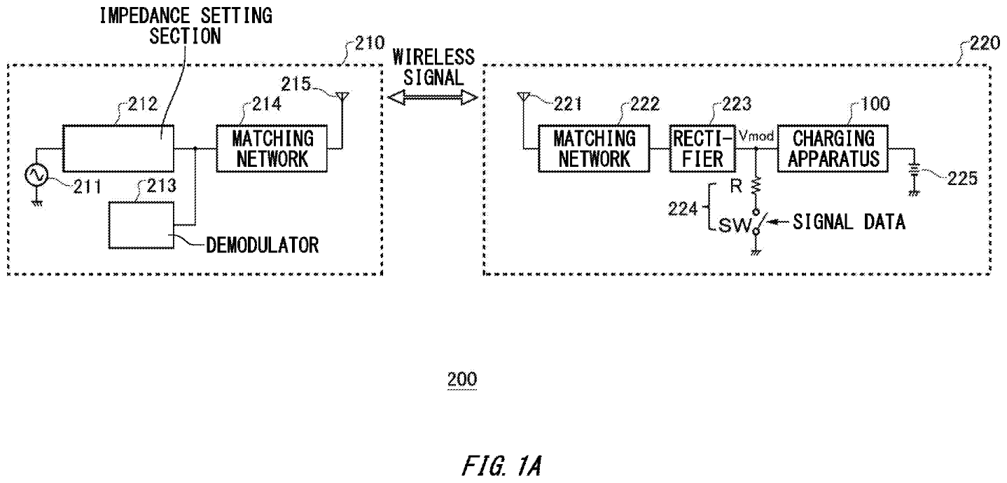

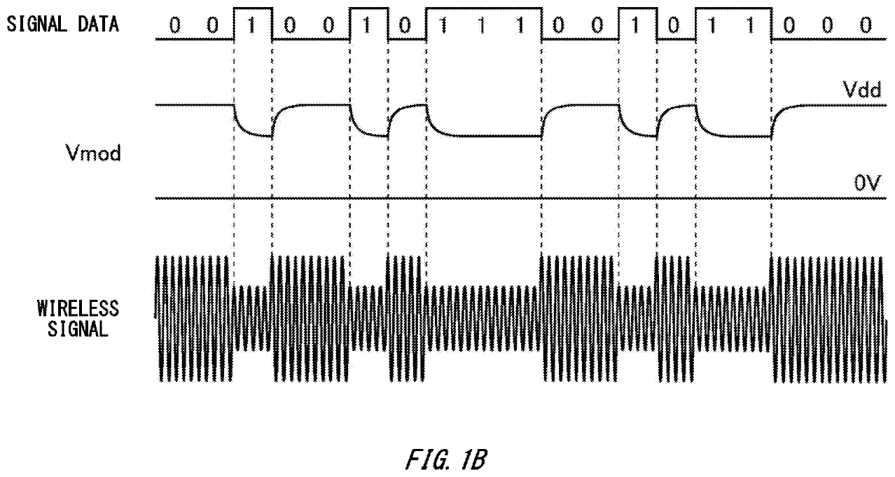

FIG. 1A shows an example of a configuration of a power supply system 200. The power supply system 200 includes a power transmitter 210 and a power receiver 220. The power supply system 200 is a wireless power supply device that charges a battery 225 by transmitting and receiving wireless signals between the power transmitter 210 and the power receiver 220.

The power transmitter 210 transmits a wireless signal for the wireless supplying of power to the power receiver 220. The power transmitter 210 includes a power source 211, an impedance setting section 212, a demodulator 213, a matching network 214, and an antenna 215. The power transmitter 210 inputs the current supplied from the power source 211 into the matching network 214, and outputs this current from the antenna 215 as a wireless signal. The impedance setting section 212 sets the impedance on the power transmission side. The demodulator 213 demodulates the signal that has been modulated on the power reception side. In this specification, the power transmission side refers to the power transmitter 210, and the power reception side refers to the power receiver 220.

The power receiver 220 receives the wireless signal from the power transmitter 210, and charges the battery 225. The power receiver 220 includes the charging apparatus 100, an antenna 221, a matching network 222, a rectifier 223, a load modulating section 224, and the battery 225. The wireless signal input from the antenna 221 is input to the charging apparatus 100 via the matching network 222 and the rectifier 223. The load modulating section 224 includes a resistor R and a switch SW, and realizes communication from the power receiver 220 to the power transmitter 210 using load modulation. The charging apparatus 100 functions as a switch charger, and charges the battery 225.

The power transmitter 210 and the power receiver 220 are coupled to each other by electromagnetic waves using the respective antennas and matching networks thereof. The power transmitter 210 has a finite impedance as a signal source, and supplies finite power to the power receiver 220. The power received by the power receiver 220 changes depending on the impedance on the power reception side, and the power on the power reception side is at maximum (i.e. maximum transmission efficiency) when the impedances on the power transmission side and the power reception side are equal.

The battery 225 is wirelessly supplied with power by the power supply system 200. The battery 225 is provided in the power receiver 220, but may instead be provided outside the power receiver 220. For example, the battery 225 is a storage battery such as a Li-ion battery. In one example, the charging of the battery 225 includes charging 80% with constant current charging and charging the remaining 20% with constant voltage charging, in order to maintain the lifetime. The power per unit time needed for charging is the product of the battery voltage VBAT and the charging current. When the charging voltage of the battery 225 increases due to the progression of the constant current charging, the necessary power per unit time increases.

Here, when power exceeding the optimal condition to be received by the power receiver 220 is taken in by the charging apparatus 100, there are cases where the input voltage of the charging apparatus 100 decreases and the power being received decreases significantly. In such a case, the transmission efficiency of the power supply system is reduced. The charging apparatus 100 according to the present example can improve the transmission efficiency of the power supply system 200 by optimally controlling the power received by the power receiver 220.

FIG. 1B is a diagram for describing the wireless signal transmitted by the power supply system 200. The power supply system 200 of the present example realizes communication between the power transmitter 210 and the power receiver 220 using load modulation. The load modulating section 224 turns the switch SW ON and OFF, based on signal data input thereto. In this way, the load modulating section 224 generates a modulated voltage Vmod by modulating the voltage input to the power receiver 220. The power transmitter 210 and the power receiver 220 transmit and receive charging information by performing communication using load modulation. In this way, by transmitting and receiving the charging information to and from the power receiver 220, the power transmitter 210 can control the ON/OFF state and adjustment of the power on the power transmission side, according to the charging progress state of the battery 225.

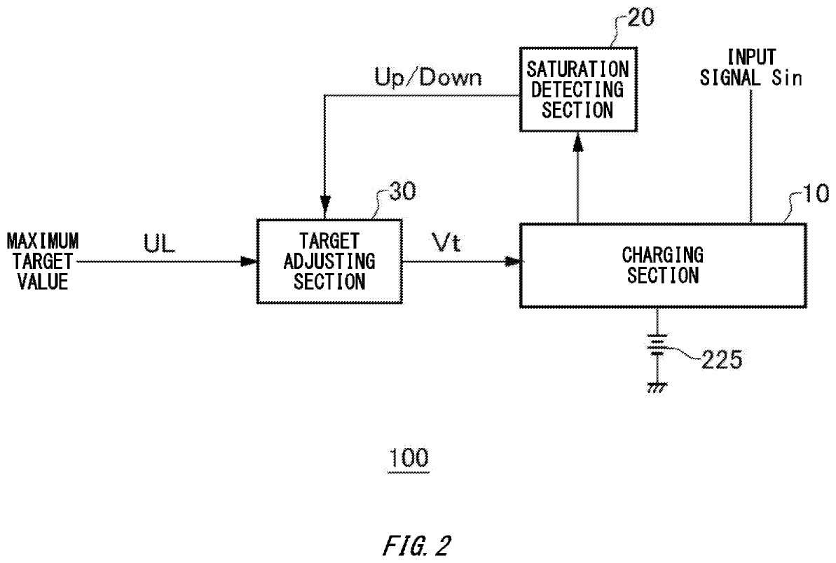

FIG. 2 shows an overview of a configuration of the charging apparatus 100 according to an embodiment. The charging apparatus 100 includes a charging section 10, a saturation detecting section 20, and a target adjusting section 30.

The charging section 10 receives an input signal Sin corresponding to the wireless signal transmitted from the power transmitter 210. The charging section 10 charges the battery 225 based on the input signal Sin. The charging section 10 includes a feedback loop that performs feedback control to charge the battery 225 to a target value Vt, described further below. For example, the charging section 10 is a DC-DC converter that includes a MOS switch and a coil.

The saturation detecting section 20 detects the state of the feedback loop of the charging section 10. The saturation detecting section 20 generates a detection signal indicating whether the feedback loop is normal or saturated. The saturation detecting section 20 inputs the generated detection signal to the target adjusting section 30.

The target adjusting section 30 adjusts the target value Vt, based on the detection result of the saturation detecting section 20. For example, the target adjusting section 30 includes an Up/Down counter. The target adjusting section 30 increases or decreases the counter output value of the Up/Down counter, according to the detection signal of the saturation detecting section 20.

The target value Vt is a target value indicating the target for the output by the charging section 10. The charging section 10 performs feedback control such that a difference between the target value Vt and an output value of an output detecting section 14, described further below, becomes 0. In other words, the charging section 10 performs feedback control such that the output detecting section 14 outputs the target value Vt. As an example, the target value Vt includes a target value of the charging current or a target value of the charging voltage.

Here, in a system for realizing the communication from the power receiver 220 to the power transmitter 210 using load modulation, when the charging current is controlled such that the input voltage of the charging apparatus 100 matches the reference voltage, there are cases where the load modulation is disrupted, and cases where the communication quality between the power transmitter 210 and the power receiver 220 is significantly degraded. In contrast to this, the charging apparatus 100 of the present example can improve the transmission efficiency without inhibiting the communication using the load modulation.

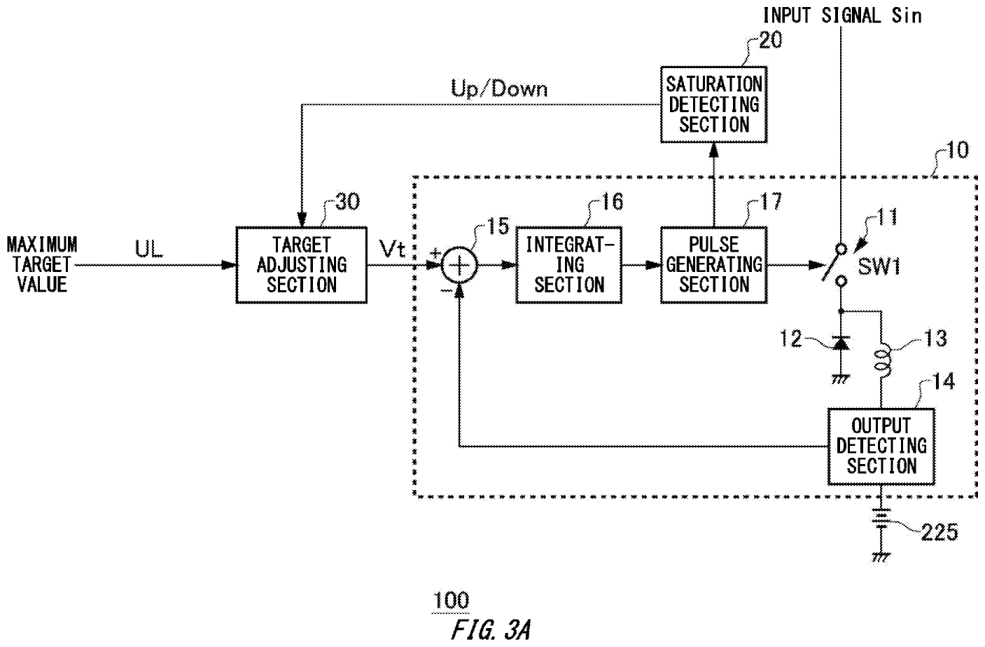

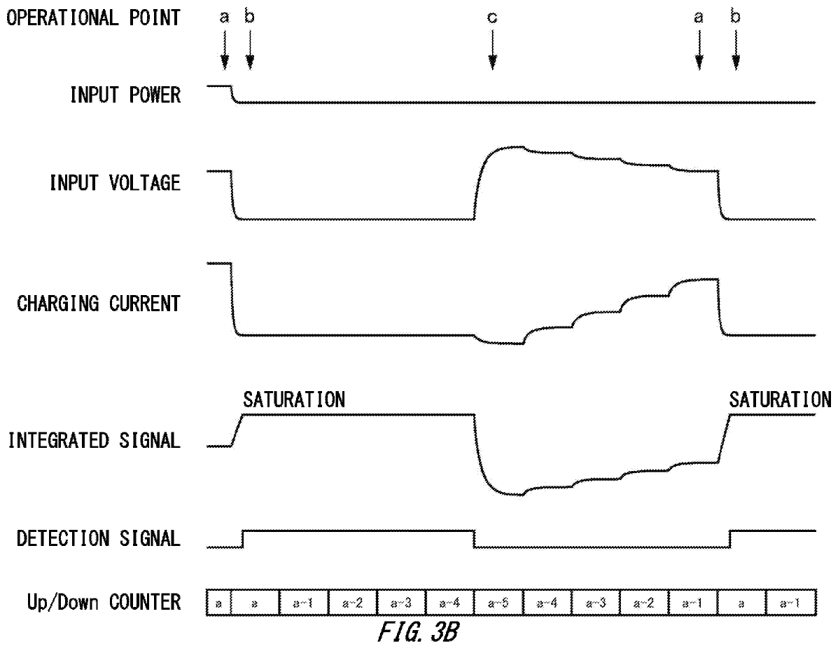

FIG. 3A shows an example of a detailed configuration of the charging apparatus 100 according to a first embodiment. The charging section 10 includes a switching section 11, a diode section 12, a coil section 13, the output detecting section 14, a difference detecting section 15, an integrating section 16, and a pulse generating section 17. The feedback loop of the charging section 10 is formed by the switching section 11, the coil section 13, the output detecting section 14, the difference detecting section 15, the integrating section 16, and the pulse generating section 17.

The switching section 11 switches whether an input terminal and the output detecting section 14 are connected. In this way, the switching section 11 switches whether the battery 225 is being charged with the power corresponding to the input signal Sin. The switching section 11 includes a switch SW1 formed by a MOS switch or the like. One end of the switch SW1 is connected to the input terminal, and the other end is connected to the diode section 12 and the coil section 13. The input signal Sin is input to the input terminal.

The cathode of the diode section 12 is connected to the other end of the switch SW1, and the anode of the diode section 12 is connected to a GND. By including the diode section 12, the charging apparatus 100 can efficiently charge the battery 225 with the power input thereto. The charging apparatus 100 may include a switch instead of the diode section 12.

One end of the coil section 13 is connected to the switch SW1. The other end of the coil section 13 is connected to the battery 225, via the output detecting section 14.

The output detecting section 14 is provided between the coil section 13 and the battery 225. The output detecting section 14 detects the current or voltage flowing from the coil section 13 to the battery 225.

The difference detecting section 15 detects a difference signal indicating the difference between the target value Vt and the signal from the output detecting section 14. As an example, the difference detecting section 15 detects a difference signal between the current value detected by the output detecting section 14 and a charging current target that is the output of the Up/Down counter of the target adjusting section 30. Alternatively, the difference detecting section 15 may detect a difference signal between the voltage value detected by the output detecting section 14 and a charging voltage target that is the output of the Up/Down counter of the target adjusting section 30.

The integrating section 16 integrates the difference signal from the difference detecting section 15. The integrating section 16 generates an integrated signal obtained by integrating the difference signal from the difference detecting section 15.

The pulse generating section 17 generates a pulse control signal corresponding to the integrated signal from the integrating section 16. The pulse generating section 17 is connected to the switching section 11, and inputs the generated pulse control signal to the switching section 11. As an example, the pulse generating section 17 inputs the generated pulse control signal to a gate terminal of the switching section 11.

The saturation detecting section 20 detects whether the feedback loop is saturated. For example, the saturation detecting section 20 detects whether the integrating section 16 or the pulse generating section 17 is saturated. The saturation detecting section 20 detects the integrating section 16 being saturated as the feedback loop being saturated.

An upper limit value UL, serving as a maximum target, is input to the target adjusting section 30. The upper limit value UL is an upper limit value of the Up/Down counter. As an example, the upper limit value UL is a setting value of the maximum charging current or a setting value of the maximum charging voltage. For example, the target adjusting section 30 decreases the target value Vt when the saturation detecting section 20 detects saturation. If the saturation detecting section 20 does not detect saturation, the target adjusting section 30 operates to increase the target value Vt, with the upper limit value UL as the upper limit.

If the input power is greater than or equal to the charging power, the target value Vt is controlled to become equal to the upper limit value UL. The pulse generating section 17 determines the ON time of the switching section 11, by generating the pulse control signal based on the integrated signal. While the switching section 11 is ON, the current flowing through the coil section 13 is ramped up based on the difference between the input voltage and the battery voltage VBAT, the charging current flows to the battery 225, and power is accumulated. On the other hand, when the switching section 11 is OFF, current flows to the battery 225 from the GND, via the diode section 12, due to the power accumulated in the coil section 13. In this way, the charging apparatus 100 can efficiently supply the battery 225 with the input power as the charging current.

Here, when the ON time of the switching section 11 becomes long, the current flowing through the coil section 13 increases and the charging current increases. When the charging current increases, the output of the integrating section 16 drops, and control is performed to shorten the ON time of the switching section 11. For example, the feedback loop of the charging section 10 performs control to cause the difference signal input to the integrating section 16 to become zero, and performs control to cause the output of the output detecting section 14 and the target value Vt to become equal. In this way, the charging apparatus 100 performs the constant current charging operation.

On the other hand, when the input power drops below the charging power, the current flowing through the coil section 13 drops and the charging current drops. When this occurs, through the output detecting section 14, the difference signal increases, the output of the integrating section 16 increases, the ON time of the switching section 11 becomes longer, and the average inflow current from the input signal Sin increases. However, since the input voltage drops due to the increase of the inflow current, the power being accumulated by the coil section 13 decreases, and the charging current further drops. As a result, the feedback loop is broken, the output of the integrating section 16 enters the saturated state, and the ON time of the switching section 11 becomes the maximum length.

When the feedback loop is saturated, the saturation detecting section 20 detects saturation, the counter output value of the Up/Down counter of the target adjusting section 30 is reduced, and the charging current drops until the feedback loop returns to normal. When the feedback loop has returned to normal, the count output value of the Up/Down counter of the target adjusting section 30 is increased.

In this way, the charging apparatus 100 can control a charging current that causes the charging power to become equal to the input power so that it enables to charge the battery 225 with maximum efficiency. Accordingly, the charging apparatus 100 can prevent a drop in the transmission efficiency, and realize optimal power transmission. FIG. 3B shows an example of a timing chart of the charging apparatus 100 according to the first embodiment. In this drawing, the input power, input voltage, charging current, integrated signal, detection signal, and counter output value of the Up/Down counter are shown in time series. The following describes each operational point a to c.

At the operational point a, the feedback loop of the charging section 10 is operating normally. Then, the input power drops, and so the input voltage and charging current also drop. At the operational point b, the saturation detecting section 20 detects saturation, and outputs the detection signal indicating saturation. The target adjusting section 30 of the present example outputs the counter output value at a predetermined interval. While the saturation detecting section 20 detects saturation, the target adjusting section 30 decreases the counter output value of the Up/Down counter. At the operational point c, the input voltage rises, and it is judged that the saturation detecting section 20 no longer detects saturation and the feedback loop is normal. If the saturation detecting section 20 does not detect saturation, the target adjusting section 30 increases the counter output value of the Up/Down counter. In this way, the charging apparatus 100 performs control to raise the charging current.

In the present example, the time intervals for the output of the Up/Down counter are controlled to be constant. In other words, the charging apparatus 100 causes the output of the Up/Down counter to change at constant intervals. This time intervals are the period of timings at which the target adjusting section 30 changes the output of the Up/Down counter.

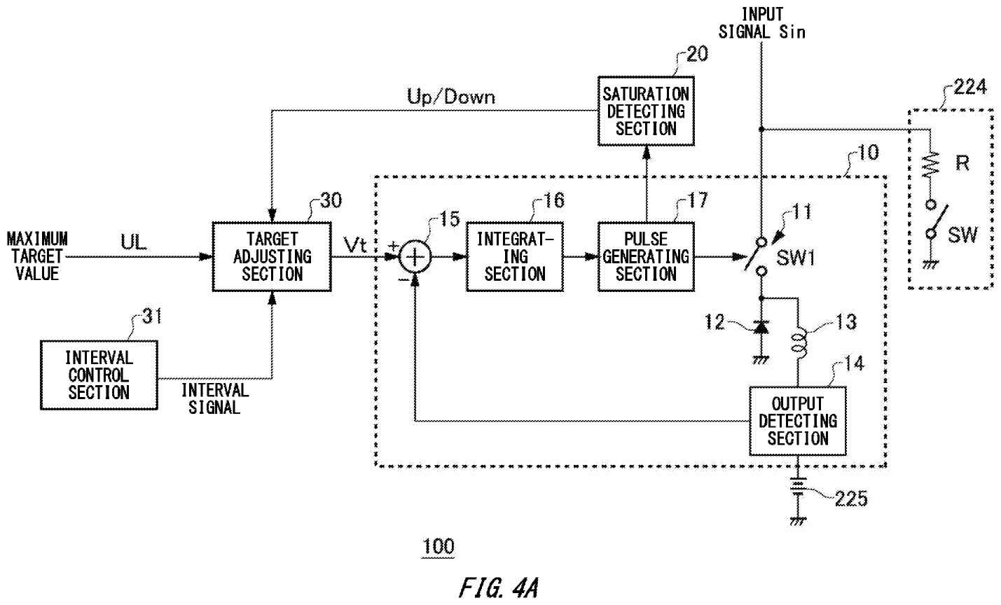

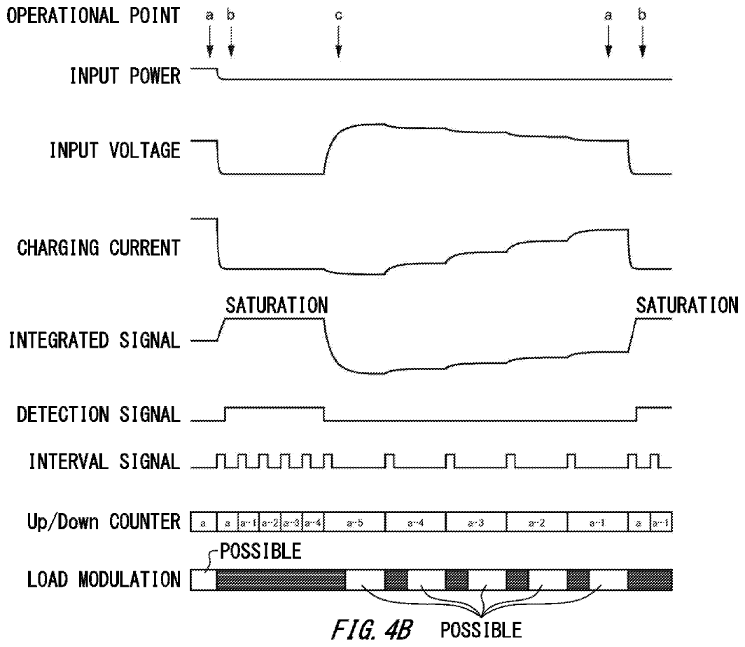

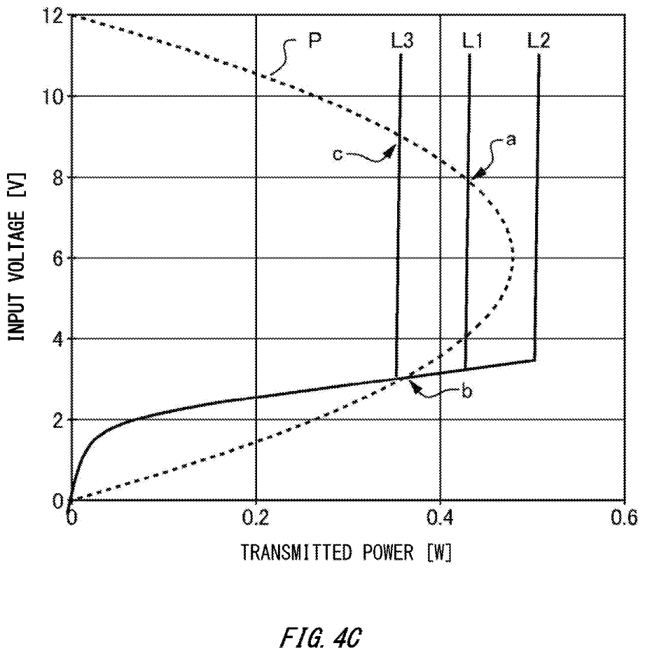

FIG. 4A shows an example of a configuration of a charging apparatus 100 according to a second embodiment. The charging apparatus 100 of the present example differs from the charging apparatus 100 according to the first embodiment by including an interval control section 31.

The interval control section 31 generates an interval signal for controlling the interval at which the target value Vt is adjusted by the target adjusting section 30. The interval control section 31 inputs the generated interval signal to the target adjusting section 30. The target adjusting section 30 increases or decreases the counter output value of the Up/Down counter, at a timing corresponding to the interval signal.

The interval signal may be a fixed value or may be variable. For example, when the saturation detecting section 20 has detected that the feedback loop is saturated, the interval control section 31 causes the time interval to be shorter than the time interval used when the feedback loop is normal.

Furthermore, the interval control section 31 may control the detection timing of the saturation detecting section 20 using the interval signal. In this case, the saturation detecting section 20 detects whether the feedback loop of the charging section 10 is saturated at a timing corresponding to the interval signal. When the saturation detecting section 20 detects that the feedback loop is saturated or normal, the target adjusting section 30 changes the target value Vt according to the detection timing.

The load modulating section 224 includes the resistor R and the switch SW to perform load modulation. The load modulating section 224 changes the impedance on the power reception side, in order to transmit the charging status to the power transmission side. For example, the charging status includes the battery voltage VBAT of the battery 225, the charging current for the battery 225, the input voltage for the charging section 10, the temperature of the battery 225, the saturation state of the feedback loop of the charging section 10, and the like. The load modulating section 224 may be provided in the charging apparatus 100.

FIG. 4B shows an example of a timing chart of the charging apparatus 100 according to the second embodiment. The timing chart of the present example shows whether load modulation of the power supply system 200 is possible. If the feedback loop is normal, load modulation is possible. On the other hand, when the feedback loop is saturated and the impedance drops, load modulation becomes not effective. Furthermore, the interval control section 31 of the present embodiment changes the interval signal to a predetermined value. The timing of the output of the Up/Down counter changes according to the interval signal.

As an example, the charging apparatus 100 can decrease the time ratio during which the feedback loop is saturated, by making the time interval variable. Specifically, the charging apparatus 100 can decrease the time ratio during which the feedback loop is saturated by shortening the time interval after the saturation detecting section 20 has detected saturation. In this way, the charging apparatus 100 can reduce the time ratio during which load modulation cannot be performed, and also increase the average value of the charging current.

FIG. 4C shows operational points of input nodes of the charging apparatus 100 according to the second embodiment. The vertical axis indicates the input voltage [V], and the horizontal axis indicates the transmitted power [W]. The input voltage is the voltage input to the charging section 10. The transmitted power indicates the power transmitted by the charging section 10.

Load lines L indicate different behaviors according to whether the feedback loop is in the normal state or the saturated state. When the feedback loop is in the normal state, the transmitted power is determined mostly unrelated to the input voltage. Therefore, the normal state load lines L are straight lines that are nearly perpendicular to the horizontal axis. On the other hand, when the feedback loop is in the saturated state, the input voltage of the load lines L is unrelated to the transmitted power, and is determined based on the battery voltage VBAT and the maximum duty Tmax/Ts of the pulse control signal. For example, the saturated state load lines L are approximately determined to be VBAT×Ts/Tmax. The load lines L include load lines L1 to L3 in respectively different situations.

The operational points are determined by the intersection points between the load lines and the parabola P. The parabola P indicates the transmitted power transmitted from the power transmission side. The transmitted power transmitted from the power transmission side forms a parabola due to the loss components of the output impedance, antenna, rectifier, and the like on the power transmission side.

The load line L1 is a load line in a case where enough power is transmitted from the power transmission side. The operational point a is the intersection point between the load line L1 and the parabola P, and indicates the feedback loop in the normal state. In this case, the charging apparatus 100 can perform constant current charging of the battery 225 with the setting value of the maximum charging current. At the operational point a, the input impedance of the charging apparatus 100 is high, and the communication of the charging information using load modulation is performed normally.

The load line L2 is a load line in a case where charging has progressed from the load line L1 and the battery voltage VBAT has increased, such that the necessary power increases and the load line moves to a higher transmitted power. At the load line L2, there is no longer an intersection point between a region in which the feedback loop is in the normal state and the parabola P, and the operational point moves to the operational point b. At the operational point b, the input voltage and transmitted power are significantly reduced compared to the case at operational point a. Furthermore, the input impedance of the charging apparatus 100 is lower than in the case at operational point a, and it becomes difficult for load modulation to work. At the operational point b, the feedback loop is saturated, the saturation detecting section 20 operates at the timing of the interval signal to reduce the charging current target, and the load line L moves the position of the load line L3.

The load line L3 is set at a lower transmitted power than the load lines L1 and L2. At the load line L3, the operational point moves to the operational point c. At the operational point c, the feedback loop is in the normal state. At the operational point c, due to the input power being recovered, the input impedance of the charging apparatus 100 becomes higher, and it is possible to perform the communication of the charging information using load modulation normally.

The charging apparatus 100 sequentially increases the charging current, at the timings of the time interval, until the feedback loop is saturated again. After the feedback loop has become saturated, the charging apparatus 100 repeats this operation of adjusting the operational point. In this way, even when the input voltage becomes insufficient during charging and the feedback loop enters the saturated state, the charging apparatus 100 changes the target value Vt to automatically return to a normal loop. Therefore, it is possible for the charging apparatus 100 to improve the charging efficiency, and to also realize communication using load modulation.

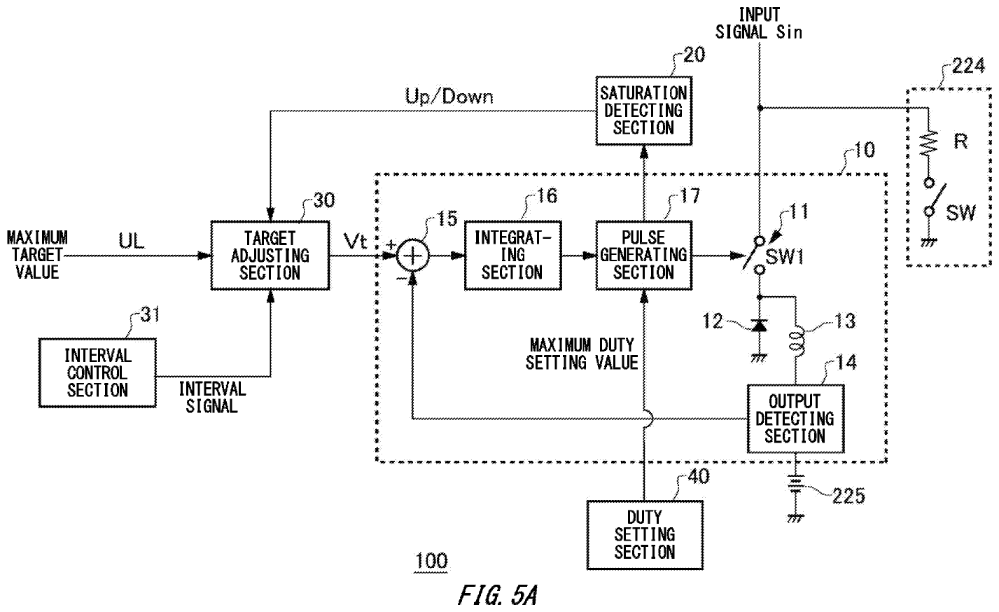

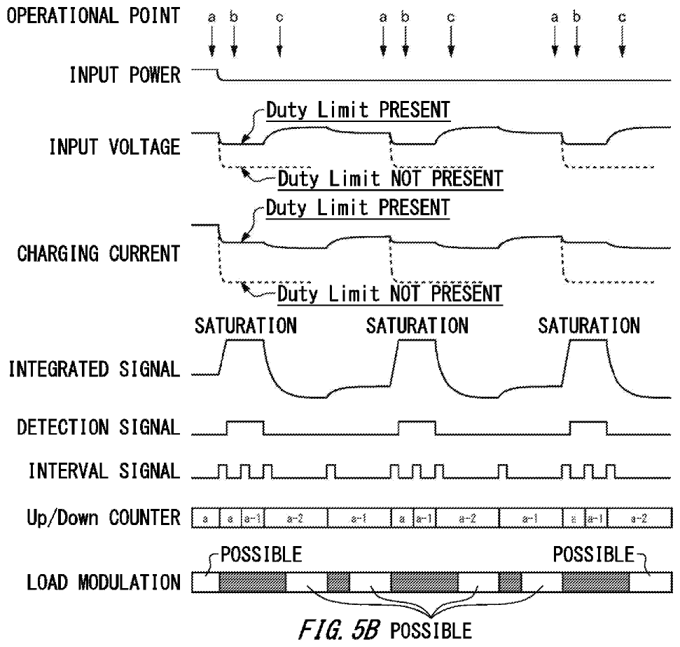

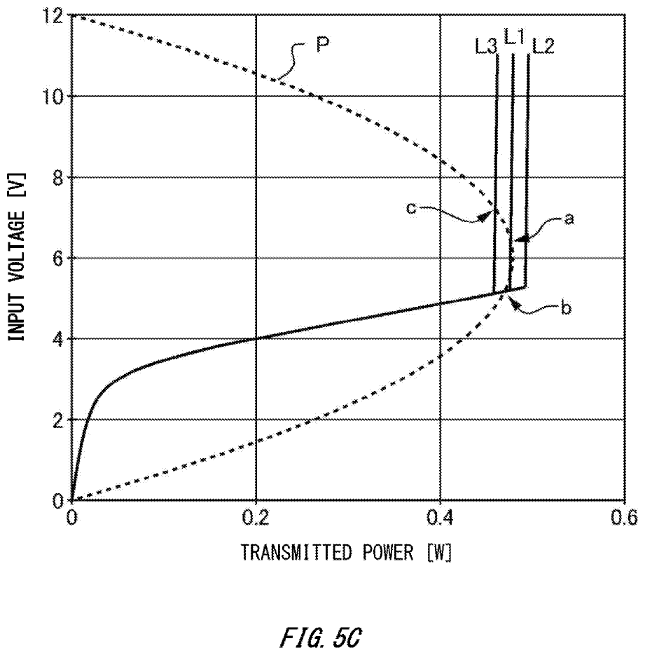

FIG. 5A shows an example of a configuration of a charging apparatus 100 according to a third embodiment. The charging apparatus 100 of the present example differs from the charging apparatus 100 according to the second embodiment by including a duty setting section 40.

The duty setting section 40 sets the maximum duty Tmax/Ts to be a predetermined value. The duty setting section 40 inputs the maximum duty setting value to the pulse generating section 17, to control the duty of the pulse. The maximum duty setting value is a setting value for limiting the maximum length of the duty of the pulse that controls ON/OFF of the switching section 11. The duty setting section 40 of the present example sets a Duty Limit as the maximum duty setting value. When the feedback loop has become saturated, the charging apparatus 100 can shorten the time until the feedback loop returns to normal by setting the maximum duty setting value with the duty setting section 40.

Here, the change of the impedance on the power reception side modulates the voltage amplitude of the antenna on the power transmission side, and is demodulated by the demodulator on the power transmission side. However, when the pulse control signal has become the maximum duty Tmax/Ts, the input voltage of the charging apparatus 100 depends on the battery voltage VBAT, and becomes fixed at VBAT×Ts/Tmax. Then, the input impedance of the charging apparatus 100 drops. When the input impedance of the charging apparatus 100 drops, it becomes difficult for the load modulation to work. Accordingly, when the feedback loop is in the saturated state, communication using load modulation is difficult.

The charging apparatus 100 of the present example can extend the time period during which the feedback loop operates normally, by setting the maximum duty setting value. Then, during the time period when the feedback loop is normal, the charging apparatus 100 can realize communication of the charging information using load modulation.

FIG. 5B shows an example of a timing chart of the charging apparatus 100 according to the third embodiment. The present example shows a case where the time period during which the feedback loop is normal, by setting Duty Limit as the maximum duty setting value.

In a case where Duty Limit is present, the drop in the input voltage and charging current is less than in a case where Duty Limit is not present. In other words, by setting Duty Limit, the charging apparatus 100 can restrict the amplitude of the input voltage and the charging current, and increase the average charging current.

The charging apparatus 100 of the present example decreases the time ratio during which the feedback loop is saturated by shortening the time interval after the saturation detecting section 20 has detected saturation, in the same manner as the charging apparatus 100 according to the second embodiment. Therefore, the charging apparatus 100 can reduce the time ratio during which load modulation cannot be performed, and further increase the average value of the charging current.

FIG. 5C shows operational points of input nodes of the charging apparatus 100 according to the third embodiment. The vertical axis indicates the input voltage [V], and the horizontal axis indicates the transmitted power [W]. The basic operation is the same as the operation of the charging apparatus 100 according to the second embodiment.

By suitably setting the maximum duty setting value, the charging apparatus 100 can restrict the drops of the input voltage and the charging current, and shorten the time period during which the feedback loop is saturated. Furthermore, the charging apparatus 100 restricts the amplitudes of the input voltage and the charging current, increases the average value of the charging current, and realizes more efficient charging.

Here, the input voltage occurring when the feedback loop is in the saturated state is approximately VBAT×Ts/Tmax. By suitably setting the maximum duty Tmax/Ts of the switching section 11, the duty setting section 40 can restrict the drop in the input voltage at the operational point b to a greater extent than in the case of the second embodiment.

Furthermore, the duty setting section 40 sets the maximum duty setting value such that VBAT×Ts/Tmax becomes closer to the input voltage corresponding to the optimal power transmission conditions. Therefore, the charging apparatus 100 can decrease the changes of the input voltage and transmitted power by a greater degree than in the second embodiment, and realize a charging operation that is closer to the maximum transmission efficiency.

As described above, the charging apparatus 100 can perform wireless supplying of power while maintaining maximum transmission efficiency, without inhibiting load modulation. Accordingly, the charging apparatus 100 can restrict the drop in transmission efficiency, and perform optimal power transmission.

While the embodiments of the present invention have been described, the technical scope of the invention is not limited to the above described embodiments. It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A charging apparatus comprising:
a charging section that receives an input signal, charges a battery based on the input signal, and includes a feedback loop that performs feedback control to charge the battery with a predetermined target value;
a saturation detecting section that detects saturation of the feedback loop; and
a target adjusting section that adjusts the target value, based on a detection result of the saturation detecting section.

2. The charging apparatus according to claim 1, wherein
the target adjusting section adjusts a charging current target or a charging voltage target of the battery as the target value.

3. The charging apparatus according to claim 1, further comprising:
an interval control section that controls an interval at which the target adjusting section adjusts the target value, by inputting an interval signal to the target adjusting section.

4. The charging apparatus according to claim 3, wherein
the interval control section causes a time interval in which the saturation detecting section has detected that the feedback loop is saturated to be shorter than a time interval in which the feedback loop is normal.

5. The charging apparatus according to claim 1, wherein
the charging section further includes:
an output detecting section that detects a voltage or a current flowing through the battery;
a difference detecting section that detects a difference signal indicating a difference between the target value and a signal from the output detecting section; and
an integrating section that generates an integrated signal obtained by integrating the difference signal, and
the saturation detecting section outputs a detection signal indicating saturation if the integrated signal is saturated.

6. The charging apparatus according to claim 5, wherein
the target adjusting section decreases the target value based on the detection signal.

7. The charging apparatus according to claim 5, further comprising:
an interval control section that controls an interval at which the target adjusting section adjusts the target value, by inputting an interval signal to the target adjusting section.

8. The charging apparatus according to claim 7, wherein
the interval control section causes a time interval in which the saturation detecting section has detected that the feedback loop is saturated to be shorter than a time interval in which the feedback loop is normal.

9. The charging apparatus according to claim 6, further comprising:
a switching section that switches whether to charge the battery or not, based on the input signal; and
a pulse generating section that inputs a pulse control signal corresponding to the integrated signal to the switching section, and
the saturation detecting section outputs a detection signal indicating the saturation if an output signal of the pulse generating section has a maximum duty.

10. The charging apparatus according to claim 9, further comprising:
a duty control section that controls the duty of a pulse for controlling ON/OFF of the switching section, by inputting a maximum duty setting value that limits a maximum length of the duty of the pulse to the pulse generating section.
